(19) United States
(12) Patent Application Publication
(10) Pub. No.: US 2007/0064861 A1
(43) Pub. Date: Mar. 22, 2007

(54) High-density, solid solution nuclear fuel and fuel block utilizing same

(75) Inventor: James W. Sterbentz, Idaho Falls, ID (US)

Correspondence Address: Alan D. Kirsch, P.O. Box 1625, Idaho Falls, ID, 83415-3899, US

(73) Assignee: Battelle Energy Alliance, LLC

(21) Appl. No.: 11/209,978

(22) Filed: Aug. 22, 2005

(51) Int. Cl. G21C 3/00

(52) U.S. Cl. 376/409

(57) ABSTRACT

A nuclear fuel element includes a core formed from a high density solid solution fissile material that is substantially free of carbon and void space. A cladding substantially surrounds the core.

### CONTRACTUAL ORIGIN OF THE INVENTION

This invention was made with Government support under Contract DE-AC07-05ID14517 awarded by the U.S. Department of Energy. The Government has certain rights in the invention.

### TECHNICAL FIELD

This invention relates generally to nuclear power systems in general and more specifically to improved nuclear fuel elements and a reactor systems utilizing the same.

### BACKGROUND

The international Generation IV nuclear reactor program is chartered with the design and development of a new class of commercial power reactors to meet the growing demand worldwide for electricity and the production of hydrogen gas. The new Generation IV reactor designs must be better than the current Generation II operating commercial power reactors, and better even than the Generation III plants which have yet to be deployed. This requires the Generation IV reactors to have superior reactor safety, economics, sustainability, and proliferation-resistance relative to the earlier nuclear reactor generations.

There are currently six Generation IV reactor types under design and development, three thermal and three fast reactors. The leading reactor type, in terms of the popularity, funding, and design maturity for near-term deployment is a high-temperature thermal reactor, known as the Very High Temperature Reactor (VHTR). The VHTR has three very important features. First, this reactor design has the capability to generate electricity with high efficiency (45-50%) using the Brayton cycle with direct gas-turbine drive. Second, the VHTR can make high-temperature nuclear process heat for hydrogen production. Third, and currently unmatched by any other commercial nuclear power reactor in the world, the VHTR core design possesses inherent nuclear safety. In other words, the VHTR has the ability to automatically and naturally shutdown (without reactor operator intervention) and remain physically intact following any postulated transient condition without control rod insertion. These three features, and in particular the latter two, have pushed the VHTR to the forefront of the Generation IV reactor design and deployment competition. Incidentally, the higher the gas outlet temperature from the VHTR core, the more efficient the nuclear heating process is in producing hydrogen gas.

Common distinguishing characteristics of the VHTR core design include a relatively low-power density, large graphite mass, annular active core with inner and outer graphite reflectors, and TRISO-coated fuel particles. These characteristics work together to establish the inherent safety feature characteristic of this reactor design. For example, during a transient or off-normal operating event, the nuclear reaction in the core can be shutdown without the insertion of the control rods. The large negative fuel Doppler coefficient of reactivity inherent in the fuel/core design can naturally suppress the nuclear chain reaction as the core heats up in temperature. Once the fission chain reaction is shutdown and the core held at a sub-critical condition, the decay heat from the fuel annulus conducts outward to the core barrel and is removed. Heat is also conducted inward into the inner graphite reactor and temporally stored in the inner graphite reflector mass until it is eventually conducted radially back through the core and out the core barrel and pressure vessel. VHTR transients are relatively slow with time constants on the order of a few days allowing plenty of time for reactor operators to respond.

Although the VHTR core design possesses inherent safety and slow transient response behavior, the TRISO-coated fuel particles actually limit the total core power. For a VHTR core rated at 600 MW(th), the TRISO-coated fuel particles will attain a temperature just under 1600° C. temperature during the postulated transient or off-normal reactor core conditions. The temperature at which the SiC carbide layer in the TRISO-coated fuel particle begins to decompose and lead to fuel particle failures is approximately 1600° C. Under normal operating conditions, the fuel peak temperatures will be approximately 1300° C. This allows for a TRISO-coated fuel particle thermal margin of only 300° C. and a relatively narrow temperature rise margin or safety margin for the VHTR in general. From a VHTR operational safety point of view, it would be very advantageous to increase this temperature margin.

Currently, there are three VHTR design concepts under study: (1) Prismatic-block VHTR (helium-4 gas coolant); (2) Prismatic-block VHTR (molten salt liquid coolant); and (3) Pebble-bed VHTR (helium-4 gas coolant). The first two concepts listed above utilize prismatic block fuel elements; the third concept utilizes pebble fuel elements. The prismatic block concepts utilize columns of stacked fuel blocks to compose the annular core. The fuel in these blocks must possess sufficient excess reactivity to meet power cycle lengths. This requires higher uranium enrichments (15.0 wt % U235) relative to the pebble-bed reactor concept with a flowing core of pebbles and low excess core reactivity requirements.

The VHTR prismatic concepts currently under consideration all utilize solid graphite prismatic fuel blocks. These fuel blocks are usually solid graphite hexagonal blocks with channels formed therein to accommodate both fuel rods (fuel compact stacks) and coolant. Coolants being considered include helium-4 gas at high temperature (e.g., 490-1000° C.) and pressure (approximately 7.12 MPa), and molten salts (e.g. FLIBE or LiF-BeF2) high temperature (e.g., 490-1000° C.), but low pressure (e.g., ˜atmospheric).

The prismatic fuel block design being considered is substantially identical to the hexagonal fuel block utilized in the Fort St. Vrain facility in Platteville, Colo. Briefly, the Fort St. Vrain prismatic fuel block has a flat-to-flat dimension of approximately 35.82-cm (14.1 inches) and a height of approximately 79.3-cm (31.22 inches). The solid graphite block has a density of approximately 1.74 g/cc. Fuel and coolant channels are drilled in the block. There are 210 fuel channels with a diameter of 12.45-mm and 108 coolant channels with a diameter of approximately 16-mm per block.

The fuel channels are filled with fuel compacts containing TRISO-coated fuel particles bound in a graphite matrix. The TRISO-coated particles are micro-spheres approximately 1-mm in diameter or less. The basic TRISO-coated particle consists of a central spheroid kernel of uranium oxide (UO₂) or uranium oxy-carbide (UCO) coated with multiple layers of carbide materials. The first coating around the kernel is a relatively thick, low density graphite buffer to absorb fission fragment kinetic energy and accommodate fission product gases and semi-volatile species. The buffer layer is then coated with a high-density pyrolytic graphite layer known as the inner pyrolytic coating (IPyC). The next coating is a silicon carbide (SiC) layer designed to contain fission product migration and provide a high strength pressure vessel containment for the particle as a whole. The final coating is a another high-density pyrolytic graphite layer known as the outer pyrolytic coating (OPyC). TRISO-coated particle designs may also have additional coatings which might include graphite protective coatings. Each particle has a specified diameter, enrichment, kernel diameter, kernel density, and fissile and fertile uranium loading.

The TRISO-coated fuel particles are then fabricated into fuel compacts. The compacts are cylindrical pellets containing the TRISO-coated particles in a low-density carbonaceous binder material. The compacts are approximately 12.45-mm in diameter and 5.08-cm in length. The compacts are then stacked in the fuel rod channels in the prismatic blocks and capped. Each compact has an associated particle packing fraction and uranium loading.

The TRISO-coated particle has since its inception been the fuel form of choice for high-temperature gas-cooled reactors (HTGRs) primarily because of the particle's strength and fission product containment barrier. It is essentially a miniature pressure vessel boundary, a pressure vessel boundary capable of limiting the release of fission products during particle burn-up under both normal and off-normal reactor operational conditions.

In addition to the narrow thermal safety margin mentioned previously, the use of TRISO-coated particle fuel has an additional drawback relative to the prismatic block VHTR core designs. Due to the need for excess reactivity at the beginning of each power cycle, the prismatic block reactor requires a certain amount of fissile uranium (U-235) that is required to meet power cycle lengths. The fissile uranium loading can be achieved with increased particle packing fraction, higher enrichment, or both. Unfortunately, the current particle packing fraction in the fuel compacts is practically limited to less than approximately 35%. The limited particle packing fraction inhibits the VHTR core performance in several ways: (1) it limits the density of uranium loading and hence the amount of U235 mass (grams) in a fuel compact which in turn can limit the length of the VHTR power cycle, (2) it drives up the uranium enrichment (approximately 15 wt % U235 for reload enrichments) to meet the fissile uranium loading requirement, and (3) the fuel channels or fuel rod diameters must be relatively large (approximately 12.45 mm in diameter) in order to accommodate enough TRISO-coated particles and again meet fissile uranium loading requirements.

It should be noted that the relatively large fuel rod or compact diameters severely decrease the overall total core reactivity. First, the larger fuel rod diameter displaces prismatic high density graphite (1.74 g/cc) with fuel compact materials, thereby displacing and hence reducing both the overall block carbon-to-uranium ratio (C:U). Reduction of carbon in the block inhibits the neutron moderation and thermalization of fission neutrons resulting in a loss of reactivity. Second, the relatively large diameter fuel rods reduce the U-238 self-shielding effect. The fertile, thermal neutron-absorbing U-238 atoms are spread over a wider area (reduced fuel lumping) with the result being that thermal neutron absorption is increased and core reactivity is again reduced. In conclusion, the larger the fuel rod diameter in a prismatic block, the less reactive the fuel block becomes and impacts the overall core reactivity and the power cycle length.

In view of the all these limitations, VHTR prismatic block design compromises are required in order to balance these limits and achieve a potentially feasible design. The small design window allowed by the packing fraction (<35%), enrichment (<20 wt %), and rod diameter limitations by no means allows for an optimized reactor design.

### SUMMARY OF THE INVENTION

A nuclear fuel element according to the teachings provided herein may include a core comprising a high density solid solution fissile material that is substantially free of carbon and void space. A cladding substantially surrounds the core.

Also disclosed is a nuclear reactor system that may comprise a prismatic fuel block that defines at least one substantially cylindrical fuel channel therein and at least one coolant channel therein. A nuclear fuel element sized to be received by the fuel channel defined by the prismatic fuel block may comprise a core comprising a high density solid solution fissile material and a cladding that substantially surrounds the core.

### BRIEF DESCRIPTION OF THE DRAWING

Illustrative and presently preferred embodiment of the invention are shown in the accompanying drawing in which:

FIG. 1 is a perspective view of one embodiment of a nuclear fuel element in accordance with the teachings of the present invention with a portion removed to reveal the core and cladding structure;

FIG. 2 is a sectional view of the nuclear fuel element illustrated in FIG. 1;

FIG. 3 is a schematic representation of a nuclear reactor system utilizing the nuclear fuel element of FIG. 1;

FIG. 4 is an end view of a hexagonal prismatic fuel block with fuel and coolant channels utilized in the reactor system of FIG. 3;

FIG. 5 is a side view in elevation of the hexagonal prismatic fuel block illustrated in FIG. 4; and

FIG. 6 is a sectional view of another embodiment of a nuclear fuel element.

### DETAILED DESCRIPTION OF THE PREFERRED EMBODIMENTS

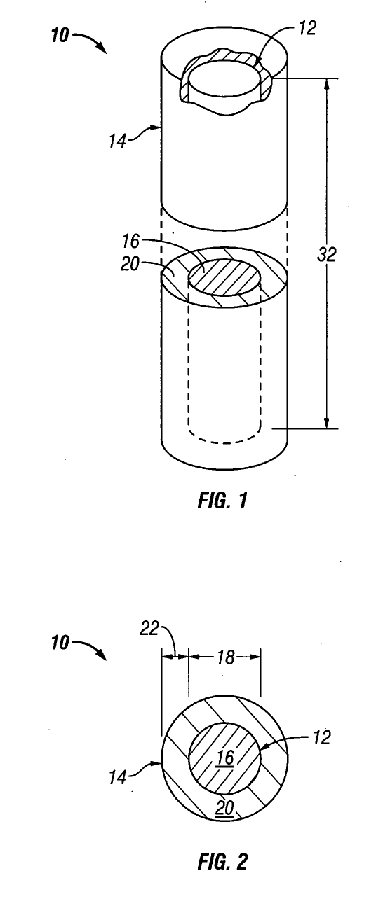

A nuclear fuel element 10 according to one embodiment of the present invention is best seen in FIGS. 1 and 2 may comprise a core 12 and a cladding 14. The core 12 comprises a high-density, solid solution fissile material 16 that is substantially free of carbon, void space, and any other materials that would reduce the density of the solid solution fissile material 16 comprising the core 12. Consequently, the core 12 of the fuel element 10 comprises a considerably higher density of fissile material 16 compared to conventional fuel elements (e.g., TRISO-coated fuel elements), which comprise fissile material kernels dispersed in carbon, carbon compounds, and/or void space.

Examples of high-density, solid solution fissile materials 16 that may comprise the core 12 include uranium oxide (UO₂); urania-zirconia-calcia (UO₂—ZrO₂—CaO); uranium nitride (UN); uranium carbide (UC₂); and uranium silicide (U₃Si₂), and mixtures thereof, although other comparable solid solution fuels may be used, as will be described in greater detail herein. The higher density of the solid solution fissile material 16 comprising the core 12 allows for a reduction in the degree of enrichment required in most applications. For example, in one embodiment, the high density solid solution fissile material 16 may comprise from about 4 wt. % to about 6 wt. % U-235, and more preferably about 5 wt. % U-235.

The high-density, solid solution fissile material 16 comprising the core 12 may be formed in any of a wide range of shapes or configurations. In the embodiment shown and described herein, the core 12 comprises a generally cylindrically-shaped, rod-like element, as best seen in FIG. 1. The generally cylindrically-shaped, rod-like core 12 may have a diameter 18 of about 6 mm or less, such as, for example, a diameter 18 in a range of about 1 mm to about 6 mm, and more preferably in a range of about 2 mm to about 4 mm.

The core 12 of fuel element 10 is surrounded by a cladding 14 that substantially encapsulates the core 12. As will be described in greater detail below, the cladding 14 functions as a fission product barrier and also as a pressure vessel or containment barrier for the high-density, solid solution fissile material 16 comprising the core 12. In one embodiment, the cladding 14 may comprise a single layer of cladding material 20, as illustrated in FIG. 2. Alternatively, and as will be described in greater detail below, the cladding 14 may comprise a multi-layer cladding 114 having multiple layers, such as inner layer 115 and outer layer 117. The multi-layer cladding 114 may be used to minimize fuel-cladding interactions and improve fission product absorption and containment. See FIG. 6.

The cladding material 20 may comprise any of a wide range of low neutron-absorbing materials, such as carbides, nitrides, and oxides. Generally speaking, carbides are more advantageous than oxides or nitrides, because the low-Z carbon atoms in carbide materials provide better neutron moderation and reactivity. The cladding material 20 should also have a high-melting point (i.e., above the expected operating temperature of the fuel element 10). Additionally, the cladding material 20 should retain a substantial portion of its strength at temperatures near its melting point. Examples of suitable cladding materials 20 include silicon carbide (SiC), zirconium carbide (ZrC), hafnium carbide (HfC), tantalum carbide (TaC), and mixtures thereof. The cladding 14 may have a thickness 22 on the order of several mm, such as, for example, in a range of about 0.5 mm to about 2 mm, and more preferably a thickness of about 1.5 mm.

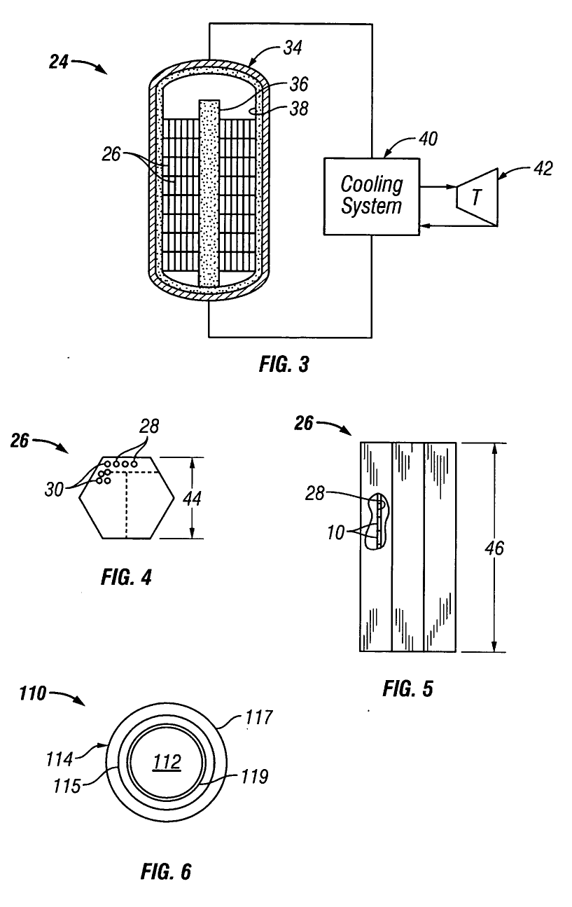

Referring now to FIGS. 3-5, the nuclear fuel element 10 may be utilized in a nuclear reactor system 24. In the embodiment shown and described herein, the nuclear reactor system 24 comprises an annular nuclear reactor core 34 comprising a plurality of prismatic-type fuel blocks 26. Each prismatic-type fuel block 26 comprises at least one, and typically a plurality (e.g., several hundred), of fuel channels 28 and coolant channels 30 formed therein. In one embodiment wherein the nuclear fuel element 10 comprises a core 12 having a generally cylindrically-shaped, rod-like configuration, the fuel channels 28 comprise generally cylindrically-shaped channels sized to closely receive a plurality of nuclear fuel elements 10, as best seen in FIG. 4. After the prismatic fuel blocks 26 are charged with the nuclear fuel elements 10, the nuclear reactor system 24 may be operated to result in the nuclear fission of the fissile material 16 comprising the fuel elements 10.

Significant advantages of the nuclear fuel elements 10 according to the present invention relate to the fabrication of the core 12 from a high density solid solution fissile material 16 that is substantially free of carbon, void space, and other materials that would reduce the density of the core 12. One advantage is that the high density core 12 allows for a much lower enrichment level (i.e., quantities of fissile material) than is typically associated with the commonly used fuel elements, such as TRISO-coated fuel particles. For example, TRISO-coated fuel particles typically involve enrichment levels in a range of about 14 wt. % to about 20 wt. % fissile material (e.g., U-235), whereas the fuel elements 10 of the present invention work well with enrichment levels in a range of about 4 wt. % to about 6 wt. % U-235. In addition to providing an economic advantage, the use of low-enrichment uranium increases the amount of U-238 present, thereby resulting in a slight increase in the breeding of additional nuclear fuel (e.g., Pu-239) during reactor operation.

In addition, the lack of carbon, void space, and other materials in the core 12 allow the fuel element 10 to be proportionally smaller, thereby resulting in an increase in the carbon-to-uranium ratio (C:U) when the fuel element 10 is used in a prismatic fuel block 24. The increased carbon-to-uranium ratio results in increased neutron moderation and core reactivity when compared to a prismatic graphite core block that is fueled with conventional fuel elements (e.g., TRISO-coated fuel particles). The smaller diameter fuel elements 10 also increase the degree of “fuel lumping” in the core. The increased degree of fuel lumping increases the U-238 self-shielding effect and reduces thermal neutron absorption by the U-238 fuel atoms, thereby resulting in increased fuel block and core reactivity. When utilized in a reactor, the nuclear fuel elements 10 can lead to significantly longer fuel burn-ups or more effective full power days for a given loading of U-235.

Additional advantages of the nuclear fuel elements 10 is that they are easier to manufacture than TRISO-coated fuel particles currently in favor. The smaller-diameter fuel rods also have a higher heat flux, leading to better heat transfer out of the fuel 10 to the surrounding graphite fuel block 26. Higher achievable fuel temperatures and thermal margins of the nuclear fuel 10 can also allow for higher core power ratings for the same physical core size. In addition, the smaller-diameter core 12 of the nuclear fuel element 10 allows the thickness 22 of the cladding 14 to be increased, thereby increasing fission product containment and clad strength.

Still yet other advantages of the nuclear fuel element 10 relate to reactor safety. For example, the high-density, solid solution fissile materials 16 utilized herein have high melting points. When combined with cladding materials 20 having high melting points, the nuclear fuel elements 10 will allow the reactor fuel to attain high temperatures without loss of physical integrity. With these higher fuel and clad melting points, the margin of safety or the temperature margin in which the fuel and clad can maintain their physical integrity during abnormal or transient conditions may be increased by 500° C.-1,000° C.

Having briefly described the nuclear fuel elements 10 of the present invention, as well as some of their more significant features and advantages, the various embodiments of the nuclear fuel elements and reactors utilizing the fuel elements will now be described in detail. However, before proceeding with the description, it should be noted that the various embodiments of the nuclear fuel elements 10 are shown and described herein as they could be configured for use in a prismatic graphite fuel block of the type proposed for one type of reactor design being considered by the international Generation IV nuclear reactor program. Alternatively, the fuel elements 10 may comprise other configurations for use in other types of reactor systems, as would become apparent to persons having ordinary skill in the art after having become familiar with the teachings provided herein. Consequently, the present invention should not be regarded as limited to the particular configurations and reactor applications shown and described herein.

Referring back now to FIGS. 1 and 2, one embodiment of a nuclear fuel element 10 may comprise a core 12 comprising a high-density, solid solution fissile material 16. As mentioned, the high-density, solid solution fissile material 16 is substantially free of carbon, void space, and any other materials that would reduce the density of the solid solution fissile material 16, hence the designation “high-density.” Examples of high-density, solid solution fissile materials 16 that may comprise the core 12 include uranium oxide (UO₂); urania-zirconia-calcia (UO₂—ZrO₂—CaO); uranium nitride (UN); uranium carbide (UC₂); and uranium silicide (U₃Si₂), and mixtures thereof. Other examples of high-density, solid solution fissile materials include plutonium compounds (PuO₂, PuC₂, PuN, and Pu₃Si) and thorium compounds (ThO₂, ThC₂, ThN, and Th₃Si). Still yet other high-density, solid solution fissile materials include so-called “mixed oxides,” such as mixture of uranium and plutonium oxides.

As mentioned, the high-density, solid solution fissile material 16 comprising the core 12 is provided in its “native” form, i.e., the high-density, solid solution fissile material 16 is not mixed carbon or any other materials which may reduce the density of the fissile material 16 compared to its native density. In addition, when formed as the core 12, the high-density, solid solution fissile material 16 is substantially free of void space, which would also serve to reduce the density of the fissile material 16. The approximate “native” densities and melting points of certain of the high-density, solid solution materials 16 that may be utilized are presented below in Table 1.

TABLE 1

| | Melting | |
|---|---|---|
| | Point | Density |
| Fissile Material | (° C.) | (g/cc) |
| uranium oxide (UO₂) | ˜2800 | 10.96 |
| urania-zirconia-calcia (UO₂—ZrO₂—CaO) | ˜2670 | 6-7 |
| uranium nitride (UN) | ˜2630 | 14.31 |
| uranium carbide (UC₂) | 2350-2400 | 11.28 |
| uranium silicide (U₃Si₂) | 1665 | 15.5 |

Because the high-density, solid solution fissile material 16 used to form the core 12 is substantially free of carbon, void space, and other materials that may reduce the density of the core, the overall density of the core 12 will be approximately equal to the native density of the fissile material 16 used to form the core 12. For example, if the fissile material 16 comprises uranium oxide having a density of about 10.96 g/cc, the resulting core 12 of fuel element 10 will have a density that is approximately equal to the density of the uranium oxide fissile material, e.g., also about 10.96 g/cc.

The high-density, solid solution fissile material 16 used to form the core 12 may be provided with a lower degree of enrichment compared to that typically required for conventional fuel forms (e.g., TRISO-coated fuel particles). For example, if the high-density fissile material 16 comprises a uranium compound, then the uranium compound may comprise from about 4 wt. % to about 6 wt. % U-235, and more preferably about 5 wt. % U-235. Plutonium compounds may comprise from about 1 wt. % to about 6 wt. % Pu-239, and more preferably about 3 wt. % Pu-239.

The high-density, solid solution fissile material 16 comprising the core 12 may be formed in any of a wide variety of shapes or configurations. By way of example, in the embodiment shown and described herein, the core 12 comprises a generally cylindrically-shaped, rod-like element having a diameter 18 of about 6 mm or less, such as, for example, a diameter 18 in a range of about 1 mm to about 6 mm, and more preferably in a range of about 2 mm to about 4 mm. The overall length 32 of the core 12 may be made to be any convenient dimension. By way of example, in one embodiment, the overall length 32 of the core 12 may be in a range of about 25 mm to about 800 mm, and more preferably in a range of about 200 mm to about 800 mm.

The core 12 of fuel element 10 is surrounded by a cladding 14 that substantially encapsulates the core 12. As mentioned above, the cladding 14 functions as a fission product barrier and also as a pressure vessel or containment barrier for the high-density, solid solution fissile material 16 comprising the core 12.

The cladding material 20 may comprise any of a wide range of low neutron-absorbing materials, such as carbides, nitrides, and oxides. Generally speaking, carbides are more advantageous that oxides or nitrides, because the low-Z carbon atoms provide better neutron moderation and reactivity. The cladding material 20 should also have a high-melting point (i.e., above the expected operating temperature of the fuel element 10). Additionally, the cladding material 20 should retain a substantial portion of its strength at temperatures near its melting point. Examples of suitable cladding materials 20 include silicon carbide (SiC), zirconium carbide (ZrC), hafnium carbide (HfC), tantalum carbide (TaC), and mixtures thereof. Hafnium carbide has the highest melting point of all known carbide materials, but may have to be enriched in one if its low thermal-neutron absorbing isotopes to provide acceptable performance. Generally speaking, silicon carbide and zirconium carbide are favored, with zirconium carbide being generally preferred due to its higher melting point (e.g., 3540° C.) compared to the melting point of silicon carbide (e.g., 2700° C.).

The cladding 14 may have a thickness 22 on the order of several mm, such as, for example, in a range of about 0.5 mm to about 2 mm, and more preferably a thickness of about 1.5 mm. The cladding 14 should also cover the end portions of the core 12 at comparable thicknesses.

Referring now to FIGS. 3-5, a plurality of the nuclear fuel elements 10 just described may be utilized in a nuclear reactor system 24. In the embodiment shown and described herein, the nuclear reactor system 24 comprises an annular core 34 comprising a plurality of prismatic-type fuel blocks 26. More specifically, in a proposed design for a Generation IV VHTR, the annular core 34 of reactor system 24 typically comprises 1020 prismatic-type fuel blocks 26 arranged around a central graphite reflector 36. The fuel blocks 26 are surrounded by an outer graphite reflector 38. The reactor system 24 is also provided with a cooling system 40. A turbine system 42 may be utilized to convert the heat energy from the cooling system 40 to mechanical energy or other forms of energy (e.g., electrical) in a manner well-known in the art.

Referring now primarily to FIGS. 4 and 5, each fuel block 26 may comprise a prismatic configuration having a generally hexagonal cross-section, although other configurations are possible. In one embodiment, each fuel block has a flat-to-flat dimension 44 of about 35.82 cm and a height 46 of approximately 79.3 cm, although fuel blocks having other dimensions may also be used. Each fuel block is fabricated from graphite having a density of about 1.74 g/cc.

Each fuel block 26 defines at least one, and typically a plurality (e.g., several hundred), of fuel channels 28 and coolant channels 30 formed therein. By way of example, each fuel block 26 in one embodiment comprises 210 fuel channels 28 and 108 coolant channels 30, although a greater or fewer numbers may be provided, depending on the particular application. In one embodiment wherein the nuclear fuel element 10 comprises a core 12 having a generally cylindrically-shaped, rod-like configuration, the fuel channels 28 comprise generally cylindrically-shaped channels sized to closely receive a plurality of nuclear fuel elements 10. By way of example, in one embodiment, each fuel channel 28 has a diameter of about 7 mm. The coolant channels 30 may be sized to provide the appropriate flow of coolant (not shown) to allow the reactor system 24 to operate at the appropriate temperature. By way of example, in one embodiment, each coolant channel 30 has a diameter of about 16 mm.

After being charged with the nuclear fuel elements 10, the nuclear reactor system 24 may be operated to result in the nuclear fission of the fissile material 16 comprising the fuel elements 10.

As briefly mentioned above, other configurations and embodiments of the fuel element 10 according to the teachings provided herein are possible. For example, and with reference now to FIG. 6, another embodiment 110 of a fuel element according to the present invention may comprise a multi-layer cladding 114. More specifically, in the embodiment illustrated in FIG. 6, the multi-layer cladding 114 may comprise an inner layer 115 and an outer layer 117, with each layer being optimized to perform a specific function. For example, the inner clad layer 115 may be fabricated from zirconium carbide (ZrC), silicon carbide (SiC) or other carbide material so that it functions well as a high-temperature fission product barrier, whereas the outer clad layer 117 may be fabricated from zirconium carbide (ZrC), silicon carbide (SiC), or other carbide material so that it functions well as a high-strength, high-integrity pressure vessel containment barrier. In addition, the inner layer 115 may be provided with a low-density pyrolytic carbon inner sheath 119 to act as a buffer between the high-density, solid solution fissile material 116 comprising the core 112 and the cladding 114 to minimize fuel-clad interactions and to improve fission product absorption and retainment.

The thicknesses of the various cladding layers 115, 117, and 119 may depend somewhat on the particular function of the cladding layer as well as on the particular material that is to be used for the layer. Consequently, the present invention should not be regarded as limited to cladding layers having any particular thicknesses. However, by way of example, in one embodiment, the thickness of first cladding layer 115 may be in a range of about 0.5 mm to about 5 mm, and more preferably a thickness of about 1.5 mm. The thickness of the second cladding layer 117 may be in a range of about 0.5 mm to about 5 mm, and more preferably a thickness of about 1.5 mm. The thickness of the inner sheath 119 may be in a range of about 0.1 mm to about 5 mm, and more preferably a thickness of about 0.2 mm.

### Computer Modeling of Burn-Up for Example Configurations

Preliminary burn-up and cycle length calculations were performed on a number of example configurations in order to demonstrate the increased burn-up capability of the fuel element of the present invention when utilized in the proposed fuel block design for the prismatic Very High Temperature Reactor (VHTR) core. More specifically, the General Atomics Gas Turbine—Modular High-Temperature Reactor (GT-MHR) prismatic annular core design comprising 1020 prismatic fuel blocks were used for a one-to-one comparison between the TRISO-coated particle fuel and the fuel element 10 of the present invention. For all example configurations, the high-density, solid solution fissile material 16 comprises uranium oxide (UO₂) formed in a core 12 having the diameters specified in the various examples. In all examples, the core 12 was encapsulated by a cladding 14. The cladding material 20 comprised silicon carbide and had a thickness 22 of about 1.5 mm. The computer programs used for the modeling were MCNP5 and ORIGEN2.2, which are available from the Radiation Safety Information Computational Center at Oak Ridge National Laboratory.

Three modeling examples were performed using two fuel block loadings, namely, 554 g and 776 g U-235 per fuel block. The first example uses the 554 g U-235 per block loading, whereas the second and third examples both use the 776 g U-235 per block loading. These two block loadings were chosen because the 554 g loading represents the amount of U-235 needed for the initial core to achieve approximately an 18-month or 540 days power cycle length for the GT-MHR with TRISO-coated particle fuel. In addition, the 776 g U-235 per block represents a half-core reload needed to achieve a second core burn-up or power cycle.

For calculation and burn-up comparison purposes, the two block loadings were assumed to be uniform across the reactor core 34, i.e. all 1020 fuel blocks 26 in the reactor core 34 have the same identical U-235 fissile loading. This made the burn-up comparison between the TRISO-coated and fuel elements 10 of the present invention relatively straight-forward.

### EXAMPLE 1

The first burn-up calculation was for the initial VHTR core (554 g U-235 per block 26). For the TRISO-coated particle fuel case, the enrichment was 10.0 wt % U-235 with a particle packing fraction of 0.24715, UCO kernel size of 425 microns in diameter, UCO density of 10.50 g/cc, and a fuel rod diameter of 12.45 mm. For the UO₂ fuel core 12 of the present invention, the enrichment was only 5.0 wt % with a diameter 18 of 3.06 mm. As mentioned, the core 12 was substantially encapsulated with a silicon carbide cladding 14 having a thickness 22 of about 1.5 mm. Thus, the overall diameter of the fuel element 10 was about 6.06 mm. The TRISO-coated particle fuel core goes subcritical at approximately 560 EFPD (Effective Full Power Day at 600 MWₜₕ total core power) and the core utilizing the fuel element 10 of the present invention at 630 EFPD. Use of the fuel element 10 of the present invention achieves a substantial increase of 70 EFPDs (13% increase). The important point here is that the power cycle can be met and exceeded with low enriched uranium (LEU) fuel and opens up the possibilities for either a much longer power cycle or perhaps a further reduction in uranium enrichment (e.g. 4 wt %) can be realized for the 18-month power cycle length.

### EXAMPLE 2

The second burn-up calculation was for a uniform core loading of reload blocks (776 g U-235 per block 26). In actual practice, only half of the core 34 would be reloaded in order to meet the 18-month power cycle goal. However for calculation purposes and one-to-one burn-up comparison the entire core 34 (i.e., 1020 fuel blocks 26) contained the 776 g U-235 loading. For the TRISO-coated particle fuel case, the enrichment was 14.0 wt % U-235 with a particle packing fraction of 0.24715, UCO kernel size of 425 microns in diameter, UCO density of 10.50 g/cc, and a fuel rod diameter of 12.45 mm. For the fuel core 12 (comprising UO₂) of the present invention, the enrichment was again only 5.0 wt % with a core diameter 18 of 3.63 mm. Thus, including a cladding 14 having a thickness 22 of about 1.5 mm, the overall diameter of the fuel element 10 was about 6.63 mm. The reactor core with TRISO-coated particle fuel goes subcritical after approximately 890 EFPDs (Effective Full Power Day at 600 MWₜₕ total core power). The reactor core with 5.0 wt % fuel elements 10 of the present invention subcritical after 815 EFPDs, or a decrease of 78 EFPDs relative to the higher enrichment (14 wt %) TRISO-coated particle reactor core.

### EXAMPLE 3

The third burn-up calculation is essentially identical to the second burn-up calculation, except the enrichment of the UO₂ fuel element 10 of the present invention is now increased slightly from 5.0 to 6.0 wt % and the diameter 18 of core 12 (e.g., comprising UO2) was diameter decreased slightly from 3.63 mm to 3.31 mm in order maintain the 776 g U-235 loading per fuel block 26. The increased enrichment is an attempt to extend the EFPD burn-up to better match the calculated TRISO-coated particle fuel core burn-up. As before, the TRISO-coated particle fuel core goes subcritical after approximately 890 EFPDs and the reactor core utilizing the fuel element 10 of the present invention now after 915 EFPD. For a one percent increase in the UO₂ core enrichment, the burn-up is increased by 100 EFPDs and is now longer than the TRISO-coated particle fuel core by 25 EFPDs.

It is quite apparent that reactor cores utilizing the fuel elements described herein are superior to the TRISO-coated particle fuel cores in terms of achieving comparable burn-ups (EFPD) with a much lower uranium enrichment.

Having herein set forth preferred embodiments of the present invention, it is anticipated that suitable modifications can be made thereto which will nonetheless remain within the scope of the invention. The invention shall therefore only be construed in accordance with the following claims:

1. A nuclear fuel element, comprising:
a core, said core comprising a high density solid solution fissile material, said core being substantially free of carbon and void space; and
a cladding substantially surrounding said core.

2. The nuclear fuel element of claim 1, wherein said core comprises a generally cylindrical shape.

3. The nuclear fuel element of claim 2, wherein said generally cylindrically shaped core has a diameter less than about 6 mm.

4. The nuclear fuel element of claim 2, wherein said generally cylindrically shaped core has a diameter in a range of about 1 mm to about 6 mm.

5. The nuclear fuel element of claim 4, wherein said generally cylindrically shaped core has a diameter in a range of about 2 mm to about 4 mm.

6. The nuclear fuel element of claim 1, wherein said cladding has a thickness in a range of about 0.5 mm to about 2 mm.

7. The nuclear fuel element of claim 6, wherein said cladding has a thickness of about 1.5 mm.

8. The nuclear fuel element of claim 1, wherein said high density solid solution fissile material comprises one or more selected from the group consisting of uranium oxide (UO₂), urania-zirconia-calcia (UO₂—ZrO₂—CaO), uranium nitride (UN), uranium carbide (UC₂), and uranium silicide (U₃Si₂).

9. The nuclear fuel element of claim 1, wherein said high density solid solution fissile material comprises one or more selected from the group of plutonium compounds (PuO₂, PuC₂, PuN, and Pu₃Si) and thorium compounds (ThO₂, ThC₂, ThN, and Th₃Si).

10. The nuclear fuel element of claim 1, wherein said high density solid solution fissile material comprises a mixed oxide.

11. The nuclear fuel element of claim 10, wherein said mixed oxide comprises a mixture of uranium and plutonium oxides.

12. The nuclear fuel element of claim 1, wherein said cladding comprises a low neutron-absorbing carbide material.

13. The nuclear fuel element of claim 1, wherein said cladding comprises one or more selected from the group consisting of zirconium carbide (ZrC) and silicon carbide (SiC).

14. The nuclear fuel element of claim 1, wherein said high density solid solution fissile material comprises from about 4 wt. % to about 6 wt. % U-235.

15. The nuclear fuel element of claim 1, wherein said high density solid solution fissile material comprises about 5 wt. % U-235.

16. The nuclear fuel element of claim 1, wherein said high density solid solution fissile material comprises from about 1 wt. % to about 6 wt. % Pu-239.

17. The nuclear fuel element of claim 1, wherein said high density solid solution fissile material comprises about 3 wt. % Pu-239.

18. The nuclear fuel element of claim 1, wherein said high density solid solution fissile material comprises one or more selected from the group consisting of uranium oxide (UO₂) having a density of about 11 g/cc, urania-zirconia-calcia (UO₂—ZrO₂—CaO) having a density of about 6-7 g/cc, uranium nitride (UN) having a density of about 14 g/cc, uranium carbide (UC₂) having a density of about 11 g/cc, and uranium silicide (U₃Si₂) having a density of about 16 g/cc.

19. A nuclear fuel element, comprising:
a generally cylindrically shaped core, said core comprising uranium oxide, said uranium oxide comprising about 4 wt. % to about 6 wt. % U-235; and
a cladding substantially surrounding said core.

20. The nuclear fuel element of claim 19, wherein said cladding comprises:
a first cladding layer substantially surrounding said core; and
a second cladding layer substantially surrounding said first cladding layer.

21. The nuclear fuel element of claim 20, wherein said first cladding layer comprises a carbide material and wherein said second cladding layer comprises a carbide material.

22. The nuclear fuel element of claim 20, wherein said first cladding layer comprises one or more selected from the group consisting of silicon carbide (SiC) and zirconium carbide (ZrC) and wherein said second cladding layer comprises one or more selected from the group consisting of silicon carbide (SiC) and zirconium carbide (ZrC).

23. The nuclear fuel element of claim 20, wherein said first cladding layer has a thickness in a range of about 0.5 mm to about 5 mm, and wherein said second cladding layer has a thickness in a range of about 0.5 mm to about 5.0 mm.

24. The nuclear fuel element of claim 20, further comprising an inner sheath between said core and said first cladding layer.

25. The nuclear fuel element of claim 24, wherein said inner sheath comprises pyrolytic carbon.

26. A nuclear reactor, comprising:
a prismatic fuel block defining at least one substantially cylindrical fuel channel therein and at least one coolant channel therein;
a nuclear fuel element sized to be received by said at least one fuel channel defined by said prismatic fuel block, said nuclear fuel element comprising:
a core, said core consisting of a high density solid solution fissile material; and
a cladding substantially surrounding said core.

27. The nuclear reactor of claim 26, wherein said high density solid solution fissile material comprises one or more selected from the group consisting of uranium oxide (UO₂), urania-zirconia-calcia (UO₂—ZrO₂—CaO), uranium nitride (UN), uranium carbide (UC₂), and uranium silicide (U₃Si₂).

28. The nuclear reactor of claim 26, wherein said high density solid solution fissile material comprises from about 4 wt. % to about 6 wt. % U-235.

29. A nuclear fuel element, comprising:
a core consisting of a high density solid solution fissile material; and
a cladding substantially surrounding said core.
